(19) United States
(12) Patent Application Publication
(10) Pub. No.: US 2007/0096460 A1
(43) Pub. Date: May 3, 2007

(54) Sleeve assembly and rocking chair incorporating the same

(76) Inventor: Red Lan, Taipei Hsien (TW)

Correspondence Address: LADAS & PARRY, 5670 WILSHIRE BOULEVARD, SUITE 2100, LOS ANGELES, CA, 90036-5679, US

(21) Appl. No.: 11/259,912

(22) Filed: Oct. 27, 2005

(51) Int. Cl. F16L 41/00

(52) U.S. Cl. 285/222

(57) ABSTRACT

A sleeve assembly is mounted on a tube having a front through hole and a rear through hole. The sleeve assembly includes a tubular body, a limiting member, and a positioning pin. The tubular body includes a front end proximate to the front through hole, a rear end proximate to the rear through hole, and an inner peripheral wall extending between the front end and the rear end and having a limiting recess proximate to the rear end and a positioning recess proximate to and opening at the front end. The limiting member includes a limiting piece extending outwardly through the rear through hole of the tube and projecting resiliently into the limiting recess. The positioning pin is inserted in the front through hole of the tube and projects into the positioning recess.

### BACKGROUND OF THE INVENTION

1. Field of the Invention

The invention relates to a sleeve assembly, more particularly to a sleeve assembly free of a riveting appearance. The invention also relates to a rocking chair incorporating the sleeve assembly.

2. Description of the Related Art

Conventionally, a sleeve is mounted around a tube and is fastened to the tube at a predetermined position by riveting. However, appearance integrality will be destroyed by the rivet connection. Additionally, the sleeve fastened to the tube by riveting cannot be rotated relative to the tube. Therefore, the application of the conventional sleeve is limited.

### SUMMARY OF THE INVENTION

The object of the present invention is to provide a sleeve assembly which can overcome the aforesaid shortcomings of the prior art.

In one aspect of this invention, a sleeve assembly is adapted to be mounted on a tube having a front through hole and a rear through hole spaced apart from each other in a longitudinal direction of the tube. The sleeve assembly includes a tubular body, a limiting member, and a positioning pin. The tubular body is adapted to be disposed around the tube to cover the front and rear through holes, and includes a front end proximate to the front through hole, a rear end proximate to the rear through hole, and an inner peripheral wall extending between the front end and the rear end and having a limiting recess proximate to the rear end, and a positioning recess proximate to and opening at the front end. The limiting member is adapted to be disposed in the tube, and includes a limiting piece extending outwardly through the rear through hole of the tube and projecting resiliently into the limiting recess. The positioning pin is adapted to be inserted in the front through hole of the tube, and projects into the positioning recess. The tubular body is rotatable, but is immobile in the longitudinal direction.

In another aspect of this invention, a rocking chair includes a chair frame and a sleeve assembly. The chair frame includes a bottom rocker. The bottom rocker includes a pair of tubes, each of which has a front through hole and a rear through hole spaced apart from each other in a longitudinal direction of the tubes. The sleeve assembly is used for preventing the bottom rocker from rocking, and includes a tubular body, a wedge part, a limiting member, and a positioning pin. The tubular body is disposed around one of the tubes to cover the front and rear through holes, and includes a front end proximate to the front through hole, a rear end proximate to the rear through hole, and an inner peripheral wall extending between the front end and the rear end and having a limiting recess proximate to the rear end, and a positioning recess proximate to and opening at the front end. The wedge part projects outwardly from the tubular body. The limiting member is disposed in said one of the tubes, and includes a limiting piece extending outwardly through the rear through hole of said one of the tubes and projecting resiliently into the limiting recess. The positioning pin is inserted in the front through hole of said one of the tubes, and projects into the positioning recess. The tubular body is rotatable between a first position in which the wedge part is located at a level higher than or equal to said one of the tubes so as to permit the bottom rocker to rock, and a second position in which the wedge part is located at a level lower than said one of the tubes so as to prevent the bottom rocker from rocking.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a rocking chair including a preferred embodiment of a sleeve assembly according to this invention in a first state;

FIG. 2 is an exploded perspective view of the preferred embodiment;

FIG. 3 is a perspective view of a sleeve member used in the preferred embodiment;

FIGS. 4 to 8 are views showing consecutive steps of installing the preferred embodiment on a tube of the rocking chair;

FIG. 9 is a perspective view of the preferred embodiment disposed at a second position on the tube of the rocking chair;

FIG. 10 is a sectional view of the preferred embodiment of FIG. 9; and

FIG. 11 is a perspective view of the rocking chair including the preferred embodiment in a second state.

### DETAILED DESCRIPTION OF THE PREFERRED EMBODIMENT

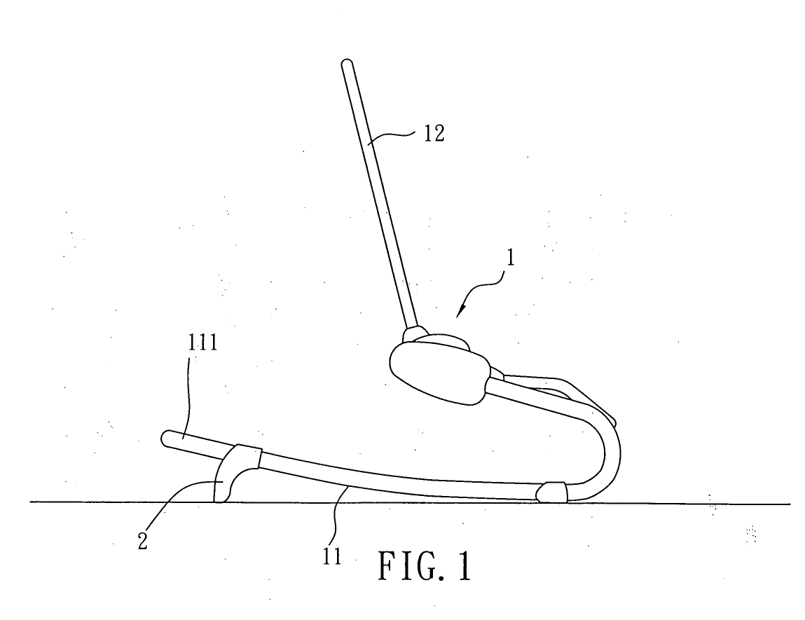

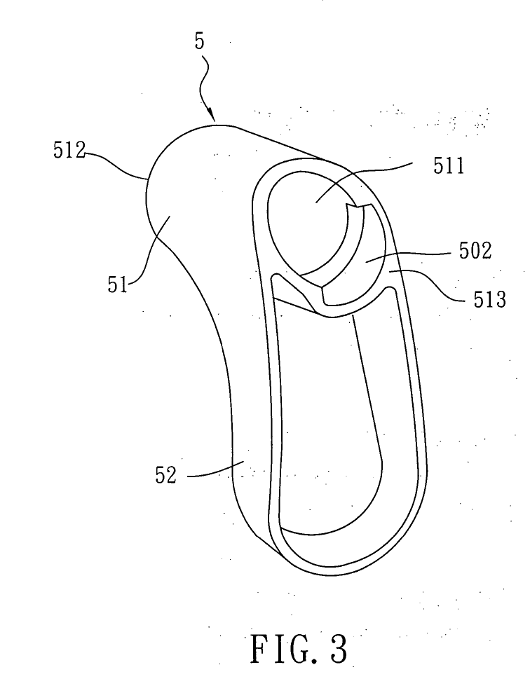

Referring to FIGS. 1, 2 and 3, the preferred embodiment of a sleeve assembly 2 according to this invention is shown to be installed on a rocking chair 1. The rocking chair 1 includes a chair frame 12 having a bottom rocker 11. The bottom rocker 11 includes a pair of tubes 111, each of which has a front through hole 112 and a rear through hole 113 spaced apart in a longitudinal direction (X) of the tubes 111. A pair of the sleeve assemblies 2 are installed around the tubes 111, respectively.

Each sleeve assembly 2 includes a sleeve member 5, a limiting member 3, and a positioning pin 4.

The sleeve member 5 includes a tubular body 51 and a wedge part 52. The tubular body 51 is disposed around the respective tube 111 to cover the front and rear through holes 112,113, and includes a front end 512 proximate to the front through hole 112, a rear end 513 proximate to the rear through hole 113, and an inner peripheral wall 511 extending between the front end 512 and the rear end 513 and having a limiting recess 502 proximate to the rear end 513 and a first positioning recess 503 proximate to and opening at the front end 512. The limiting recess 502 opens at the rear end 513 of the tubular body 51. The wedge part 52 projects outwardly from the tubular body 51. The tubular body 51 further includes a second positioning recess 505 proximate to the front end 512 and spaced apart angularly from the first positioning recess 503, a sliding recess 504 formed between the first and second positioning recesses 503,505 and spaced apart angularly from the first and second positioning recesses 503,505, and two rib portions 506, one of which protrudes between the first positioning recess 503 and the sliding recess 504, and the other one of which protrudes between the second positioning recess 505 and the sliding recess 504. The distance between the limiting recess 502 and the first positioning recess 503 (or the second positioning recess 505) is substantially equal to that between the front through hole 112 and the rear through hole 113 of the corresponding one of the tubes 111.

The limiting member 3 is disposed in the corresponding one of the tubes 111, and includes a resilient bent plate 31 disposed inside the corresponding one of the tubes 111, and a limiting piece 32 extending outwardly from the resilient bent plate 31 and through the rear through hole 113 of the corresponding one of the tubes 111 and projecting resiliently into the limiting recess 502. The resilient bent plate 31 includes a flat plate portion 311, an urging plate portion 313, and a resilient intermediate portion 312 interconnecting the flat plate portion 311 and the urging plate portion 313. The limiting piece 32 extends from the flat plate portion 311 of the resilient bent plate 31. The limiting recess 502 of the tubular body 51 is elongated in an angular direction, and the limiting piece 32 is movable circumferentially in the limiting recess 502.

The positioning pin 4 is inserted in the front through hole 112 of the corresponding one of the tubes 111, and projects into the first positioning recess 503. The positioning pin 4 includes a head portion 41 positioned in the first positioning recess 503, and a shank portion 42 extending from the head portion 41 into the front through hole 112 of the corresponding one of the tubes 111. The rib portions 506 and the sliding recess 504 are slidable over the positioning pin 4 when the tubular body 51 is rotated relative to the corresponding one of the tubes 111.

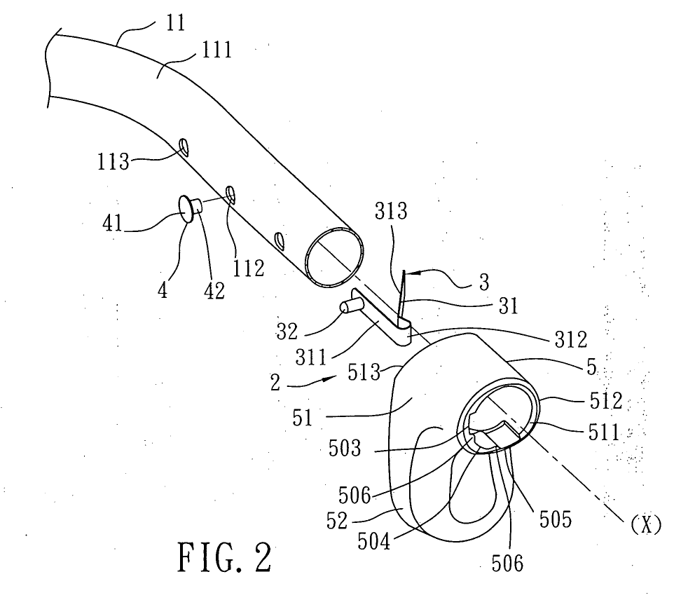

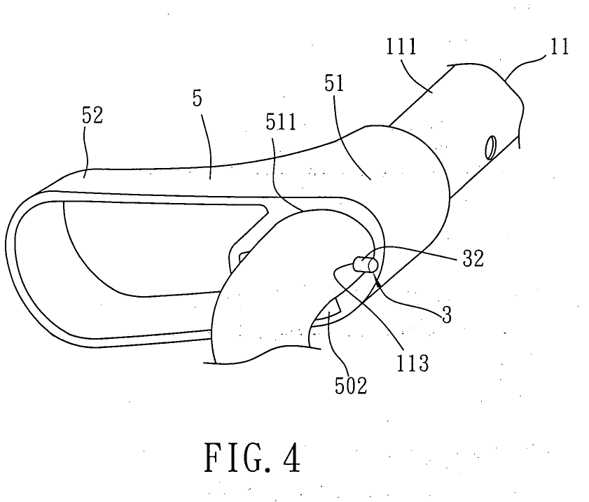

Referring to FIGS. 2, 4 and 5, during assembly, the limiting member 3 is inserted into the corresponding one of the tubes 111 so that the limiting piece 32 extends outwardly through the rear through hole 113 of the corresponding one of the tubes 111 so as to limit the limiting member 3 in a predetermined position of the corresponding one of the tubes 111.

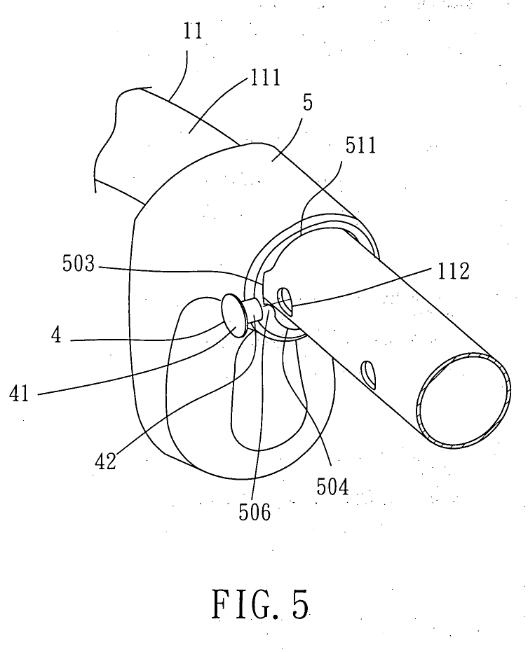

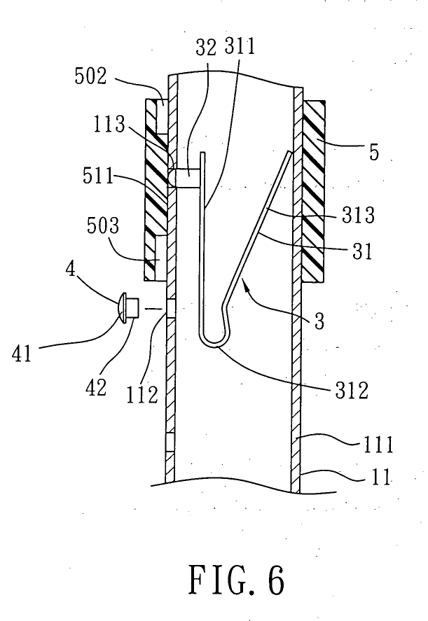

The sleeve member 5 is sleeved on the corresponding one of the tubes 111 in a manner that the wedge part 52 is kept in a substantially horizontal level and that the limiting recess 502 is opposite to the front and rear through holes 112,113. When the rear end 513 of the tubular body 51 of the sleeve member 5 reaches the limiting piece 32, the limiting piece 32 is pushed into the corresponding one of the tubes 111 so that the sleeve member 5 can continue to move along the corresponding one of the tubes 111 and that the limiting piece 32 abuts against the inner peripheral wall 511 of the tubular body 51. When the sleeve member 5 is moved along the corresponding one of the tubes 111 until the front through hole 112 is exposed, the sleeve member 5 is rotated relative to the corresponding one of the tubes 111 so that the wedge part 52 of the sleeve member 5 is at a substantially vertical position. At this time, the first positioning recess 503 corresponds to the front through hole 112 of the corresponding one of the tubes 111, best shown in FIGS. 5 and 6.

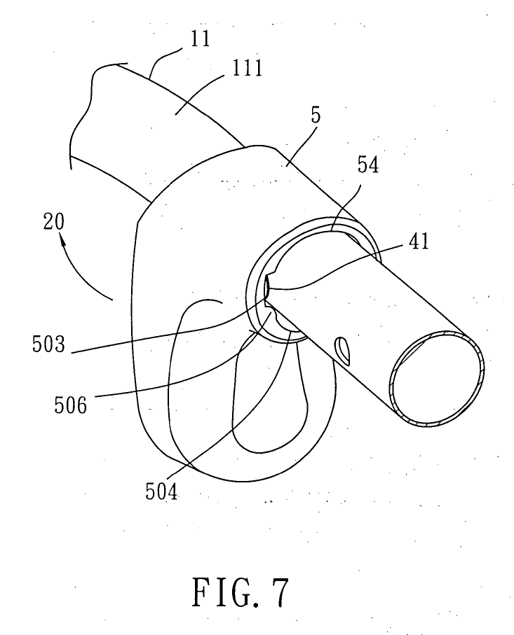

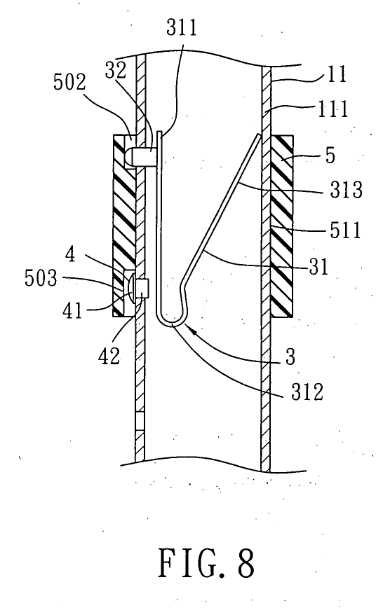

Referring to FIGS. 7 and 8, the shank portion 42 of the positioning pin 4 is inserted into the front through hole 112 of the corresponding one of the tubes 111 so that the head portion 41 thereof abuts against the corresponding one of the tubes 111. The sleeve member 5 is then moved so that the head portion 41 of the positioning pin 4 is positioned in the first positioning recess 503. At this time, the limiting piece 32 once again extends outwardly through the rear through hole 113 of the corresponding one of the tubes 111 so as to be limited in the limiting recess 502.

Since the head portion 41 of the positioning pin 4 and the limiting piece 32 are limited in the first positioning recess 503 and the limiting recess 502, respectively, the sleeve assembly 2 can not move relative to the corresponding one of the tubes 111 in the longitudinal direction (X). Furthermore, at this time, the sleeve member 5 is at a position in which the wedge part 52 of the sleeve member 5 is located at a level lower than the corresponding one of the tubes 111 so as to prevent the bottom rocker 11 from rocking.

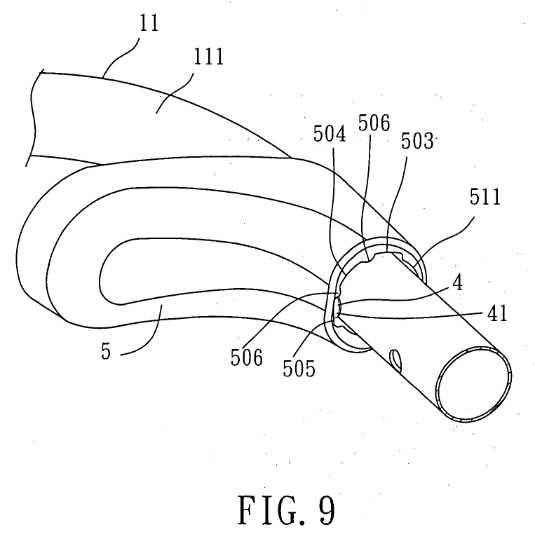

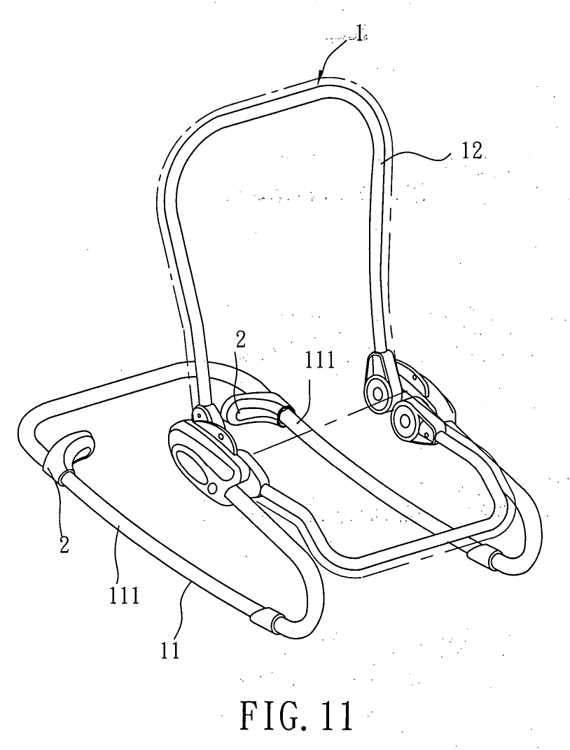

Referring to FIGS. 7, 9 and 10, when the sleeve member 5 is rotated relative to the corresponding one of the tubes 111 in a direction (20), the rib portions 506 are slidable over the head portion 41 of the positioning pin 4 so that the head portion 41 of the positioning pin 4 can be moved from the first positioning recess 503 to the second positioning recess 505 via the sliding recess 504. At this time, the sleeve member 5 is at a position in which the wedge part 52 of the sleeve member 5 is located at a level equal to the corresponding one of the tubes 111 so as to permit the bottom rocker 11 to rock, as shown in FIG. 11.

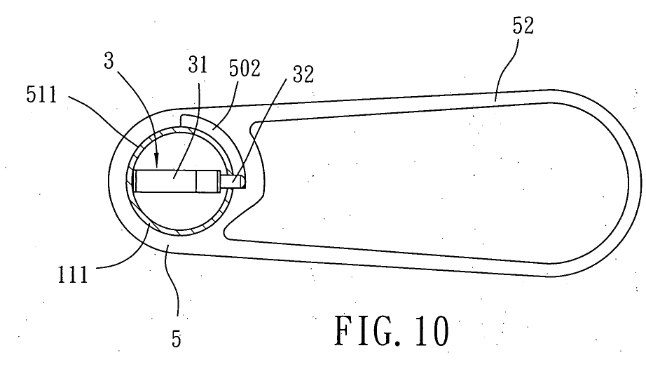

As shown in FIG. 10, when the wedge part 52 of the sleeve member 5 is located at a level equal to the corresponding one of the tubes 111, the limiting piece 32 abuts against one edge of the limiting recess 502. Therefore, the sleeve member 5 can not be rotated further relative to the corresponding one of the tubes 111 in the direction (20). Similarly, when the wedge part 52 of the sleeve member 5 is located at the position shown in FIG. 7, the limiting piece 32 abuts against the other edge of the limiting recess 502.

In view of the aforesaid, the sleeve assembly 2 of this invention is free of a riveting appearance. Therefore, appearance integrality can be ensured for the sleeve assembly 2 of this invention.

It should be noted that, in addition to the rocking chair, the sleeve assembly 2 of this invention can also be used on other baby products such as strollers, cribs, carry-cots, bassinets, frame carriers, etc. Furthermore, the sleeve assembly 2 of this invention can have patterns or logos thereon.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A sleeve assembly adapted to be mounted on a tube having a front through hole and a rear through hole spaced apart from each other in a longitudinal direction of the tube, said sleeve assembly comprising:
a tubular body adapted to be disposed around the tube to cover the front and rear through holes, and including a front end proximate to the front through hole, a rear end proximate to the rear through hole, and an inner peripheral wall extending between said front end and said rear end and having a limiting recess proximate to said rear end and a first positioning recess proximate to and opening at said front end;
a limiting member adapted to be disposed in the tube, and including a limiting piece extending outwardly through the rear through hole of the tube and projecting resiliently into said limiting recess; and
a positioning pin adapted to be inserted in the front through hole of the tube and projecting into said first positioning recess, wherein said tubular body is rotatable, but is immobile in the longitudinal direction.

2. The sleeve assembly as claimed in claim 1, wherein said limiting member further includes a resilient bent plate disposed inside the tube, said limiting piece projecting outwardly from said resilient bent plate.

3. The sleeve assembly as claimed in claim 1, wherein said positioning pin includes a head portion positioned in said first positioning recess and a shank portion extending from said head portion into the front through hole of the tube.

4. The sleeve assembly as claimed in claim 1, wherein said tubular body further includes a second positioning recess proximate to said front end and spaced apart angularly from said first positioning recess, and a rib portion protruding between said first and second positioning recesses, said rib portion being slidable over said positioning pin when said tubular body is rotated relative to the tube.

5. The sleeve assembly as claimed in claim 4, wherein said limiting recess is elongated in an angular direction, said limiting piece being movable circumferentially in said limiting recess.

6. The sleeve assembly as claimed in claim 1, wherein said limiting recess opens at said rear end of the tubular body.

7. A rocking chair, comprising:
a chair frame including a bottom rocker, said bottom rocker including a pair of tubes, each of which has a front through hole and a rear through hole spaced apart from each other in a longitudinal direction of said tubes; and
a sleeve assembly for preventing said bottom rocker from rocking, and including:
a tubular body disposed around one of said tubes to cover said front and rear through holes, and including a front end proximate to said front through hole, a rear end proximate to said rear through hole, and an inner peripheral wall extending between said front end and said rear end and having a limiting recess proximate to said rear end and a first positioning recess proximate to and opening at said front end;
a wedge part projecting outwardly from said tubular body;
a limiting member disposed in said one of said tubes, and including a limiting piece extending outwardly through said rear through hole of said one of said tubes and projecting resiliently into said limiting recess; and
a positioning pin inserted in said front through hole of said one of said tubes and projecting into said first positioning recess, wherein said tubular body is rotatable between a first position in which said wedge part is located at a level higher than or equal to said one of said tubes so as to permit said bottom rocker to rock, and a second position in which said wedge part is located at a level lower than said one of said tubes so as to prevent said bottom rocker from rocking.

8. The rocking chair as claimed in claim 7, wherein said limiting member further includes a resilient bent plate disposed inside said one of said tubes, said limiting piece projecting outwardly from said resilient bent plate.

9. The rocking chair as claimed in claim 7, wherein said positioning pin includes a head portion positioned in said first positioning recess and a shank portion extending from said head portion into said front through hole of said one of said tubes.

10. The rocking chair as claimed in claim 7, wherein said tubular body further includes a second positioning recess proximate to said front end and spaced apart angularly from said first positioning recess, and a rib portion protruding between said first and second positioning recesses, said rib portion being slidable over said positioning pin when said tubular body is rotated relative to said one of said tubes.

11. The rocking chair as claimed in claim 10, wherein said limiting recess is elongated in an angular direction, said limiting piece being movable circumferentially in said limiting recess.

12. The rocking chair as claimed in claim 1, wherein said limiting recess opens at said rear end of said tubular body.
